(19) United States
(12) Patent Application Publication
(10) Pub. No.: US 2001/0046096 A1
(43) Pub. Date: Nov. 29, 2001

(54) Redactable recording apparatus

(76) Inventor: Kerry Worden, San Ramon, CA (US)

Correspondence Address: Richard C. Litman, LITMAN LAW OFFICES, LTD., P.O. Box 15035, Arlington, VA, 22215, US

(21) Appl. No.: 09/798,911

(22) Filed: Mar. 6, 2001

Related U.S. Application Data
(60) Provisional application No. 60/187,010, filed on Mar. 6, 2000.

(51) Int. Cl. G06F 12/00

(52) U.S. Cl. 360/13; 711/111; 360/15

(57) ABSTRACT

A redactable recording apparatus with at least one recording device housed in a single unit. The single unit also includes a microprocessor and a memory device. The at least one recording: device utilized in the redactable recording apparatus may be either digital or analog. The redactable recording apparatus also includes an output device such as a speaker or screen to provide the ability for the user to review the contents of the recordings devices. The redactable recording apparatus includes a ‘take a note’ button for encoding an electronic signal onto a recording device relating to a predetermined period of time. The redactable recording apparatus includes conventional power elements.

### CROSS-REFERENCE TO RELATED APPLICATION

This application claims the benefit of U.S. Provisional Patent Application Serial No. 60/187,010, filed Mar. 6, 2000.

### BACKGROUND OF THE INVENTION

1. Field of the Invention

The present invention relates generally to a technique for editing information recorded on at least one recording device and recording the edited segments on the at least one recording device.

2. Description of Related Art

Information recorded on analog and digital recorders frequently have segments which are of less interest for playback than other segments. Thus, for example, in the recording of broadcast movies, commercials are frequently interspersed between segments of the movie. When playing back the recorded movie, it may be desirable to skip the commercials so that the continuity of story line or action may be shown uninterrupted. Similarly, when a video camera is used to record sequences on magnetic tape, it may be desirable to edit the sequences to eliminate showing out of focus or uninteresting scenes. It may also be desirable to rearrange the sequences in an order other than the order in which they were recorded on tape.

The related art is represented by the following patents of interest.

U.S. Pat. No. 3,372,240, issued on Mar. 5, 1958 to John S. Boyers et al., describes an apparatus for converting time indications into recordable digital signals and to apparatus for recording and reproducing such signals. Boyers et al. do not suggest a redactable recording apparatus according to the claimed invention.

U.S. Pat. No. 4,845,564, issued on Jul. 4, 1989 to Kunio Hakamada et al., describes a system for VCR recording on a split-screen television. Hakamada et al. do not suggest a redactable recording apparatus according to the claimed invention.

U.S. Pat. No. 5,008,871, issued on Apr. 16, 1991 to Joseph A. Howells et al., describes a digital dictation system which permits simultaneous dictation and transcription of the same message from a central store and that permits the store to be accessed by way of a port which normally enables transcribe operations to be carried out but which may be conditioned for operation as a dictate port. Howells et al. do not suggest a redactable recording apparatus according to the claimed invention.

U.S. Pat. No. 5,031,113, issued on Jul. 9, 1991 to Werner Höllerbauer, describes an integrated dictation and word processing device, which uses digital audio technology to record the spoken word onto common portable means such as a floppy disk. Höllerbauer does not suggest a redactable recording apparatus according to the claimed invention.

U.S. Pat. No. 5,231,670, issued on Jul. 27, 1993 to Richard S. Goldhor et al., describes a system and method for generating text from a voice input by dividing the processing of each speech event into a dictation event and a text event. Goldhor et al. do not suggest a redactable recording apparatus according to the claimed invention.

U.S. Pat. No. 5,239,420, issued on Aug. 24, 1993 to Seung L. Choi, describes a triple deck recording and reproducing system into which two VHS format video decks and an 8 mm or 4 mm format video deck are incorporated into a single video tape recorder. Choi does not suggest a redactable recording apparatus according to the claimed invention.

U.S. Pat. No. 5,426,534, issued on Jun. 20, 1995 to Shingo Nakata, describes a multiple-deck magnetic information recording and reproducing apparatus which is capable of dubbing recorded information from one magnetic tape to another magnetic tape. Nakata does not suggest a redactable recording apparatus according to the claimed invention.

U.S. Pat. No. 5,787,334, issued on Jul. 28, 1998 to Michel Fardeau et al., describes a method and apparatus for automatically identifying a program broadcast by a radio station or by a television channel, or recorded on a medium, by adding an inaudible encoded message to the sound signal of the program, the message identifying the broadcasting channel or station, the program, and/or the exact date. Fardeau et al. do not suggest a redactable recording apparatus according to the claimed invention.

U.S. Pat. No. 5,810,600, issued on Sep. 22, 1998 to Toshio Okada, describes a voice recording/reproducing apparatus suitable for use in a language laboratory that operates with a disk on which are recorded text segments comprising sentences and a table of contents containing text and sentence addresses. Nakata does not suggest a redactable recording apparatus according to the claimed invention.

U.S. Pat. No. 5,819,005, issued on Oct. 6, 1998 to Daniel F. Daly et al., describes a modular digital recording system that records audio on digital audio tapes that provides redundancy and the ability to record audio while listening to portions of audio that had been recorded on digital audio tape. Nakata does not suggest a redactable recording apparatus according to the claimed invention.

U.S. Pat. No. 6,178,426 issued on Jan. 23, 2001 to Klein et al. discloses a computer implemented apparatus which captures multimedia data from a user into a form specified in accordance with a markup language such as hypertext markup language. The user selects a data type such as text, handwriting, voice, image and video data type to be captured. Once the user indicates the type of data to be captured, the apparatus enables a transducer associated with the selected data type to capture data and compress data in a buffer. This data is formatted in the markup language form for subsequent storage and display. The use of the buffer feature is incorporated herein by reference.

Germany Patent document 3,518,337, published on Dec. 4, 1986, describes a voice input device for printing. Germany '337 does not suggest a redactable recording apparatus according to the claimed invention.

Japan Patent document 59-87542, published on May 21, 1984, describes a voice input device for printing. Japan '542 does not suggest a redactable recording apparatus according to the claimed invention.

Japan Patent document 59-177644, published on Oct. 8, 1984, describes an input device of Japanese language information. Japan '644 does not suggest a redactable recording apparatus according to the claimed invention.

None of the above inventions and patents, taken either singly or in combination, is seen to describe the instant invention as claimed.

### SUMMARY OF THE INVENTION

The present invention is a redactable recording apparatus. Generally, the redactable recording apparatus comprises at least one recording device housed in a single unit. Preferably, the single unit is relatively small in size so as to provide a user with a portable redactable recording apparatus. The single unit also includes a microprocessor and a memory device. The at least one recording device utilized in the redactable recording apparatus may be either digital or analog. For example, the at least one recording device could be analog in the form of recordable magnetic media, such as audio tape, video tape, or the like. The redactable recording apparatus also includes an output means such as a speaker or screen to provide a means for the user to review the contents of the recording devices. The redactable recording apparatus includes a ‘take a note’ button for encoding an electronic signal onto a recording device relating to a predetermined period of time. The redactable recording apparatus preferably includes a plurality of such ‘take a note’ buttons, each representing a varying “note length”, such as 20 seconds, 40 seconds, one minute, three minutes, etc. Obviously, the redactable recording apparatus includes conventional power means, such as batteries.

The operation of the redactable recording apparatus will now be described. Consider a redactable recording apparatus student user wishing to generate a recording of a school lecture. The student would activate the redactable recording apparatus at the beginning of the lecture. A ‘full version’ recording device would begin recording the lecture. During the lecture, the student user would mark edit points at desired times with ‘take a note’ buttons.

At the end of the lecture, the student user would rewind the ‘full version’ recording device or the ‘full version’ recording device would automatically rewind. During the rewind of the ‘full version’ recording device the microprocessor will search for edit points marked by the user. When an edit point was reached, the redactable recording apparatus would stop rewinding or retracking the ‘full version’ recording device and start playing the ‘full version’ recording device. At the same time the redactable recording apparatus would activate an ‘edit full version’ recording, device and record the ‘full version’ recording device contents for the period of time designated by the edit point. This process continues throughout the length of the ‘full version’ recording device. Obviously, the ‘full version’ recording device and the ‘edit full version’ recording device could be configured in the form of a single digital recording device with different memory locations.

Accordingly, it is a principal object of the invention to provide a redactable recording apparatus with at least one recording device housed in a single unit for conveniently recording an event and generating a recorded edited version of the event

It is another object of the invention to provide a redactable recording apparatus with at least one digital recording device.

It is a further object of the invention to provide a redactable recording apparatus with at least one analog recording device.

It is an object of the invention to provide improved elements and arrangements thereof in a redactable recording apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a block diagram of a redactable recording device apparatus according to the present invention.

FIG. 2 is a simplified flow chart of a recording process utilizing a redactable recording device apparatus according to the present invention.

FIGS. 3A-3B illustrate an interconnected and expanded version of the flow chart shown in FIG. 2 of a recording process utilizing a redactable recording device apparatus according to the present invention.

Similar reference characters denote corresponding features consistently throughout the attached drawings.

### DETAILED DESCRIPTION OF THE PREFERRED EMBODIMENTS

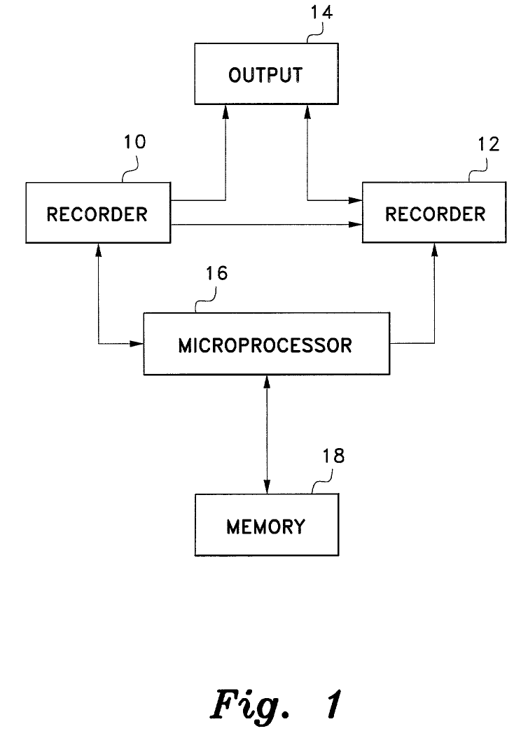

The present invention is a redactable recording apparatus. FIG. 1 illustrates a block diagram of a redactable recording apparatus according to the present invention. Generally, the redactable recording apparatus comprises at least one recording device 10, 12 housed in a single unit. Preferably, the single unit is relatively small in size so as to provide a user with a portable redactable recording apparatus. The single unit also includes a microprocessor 16 and a memory device 18. The at least one recording device 10, 12 utilized in the redactable recording apparatus may be either digital or analog. For example, the at least one recording device 10, 12 could be analog in the form of recordable magnetic media, such as audio tape, video tape, or the like. The redactable recording apparatus also includes an output means 14 such as a speaker or screen to provide a means for the user to review the contents of the recording devices. The redactable recording apparatus includes a ‘take a note’ button for encoding an electronic signal onto a recording device relating to a predetermined period of time. The redactable recording apparatus preferably includes a plurality of such ‘take a note’ buttons, each representing a varying “note length”, such as 20 seconds, 40 seconds, one minute, three minutes, etc. Obviously, the redactable recording apparatus includes conventional power means, such as batteries.

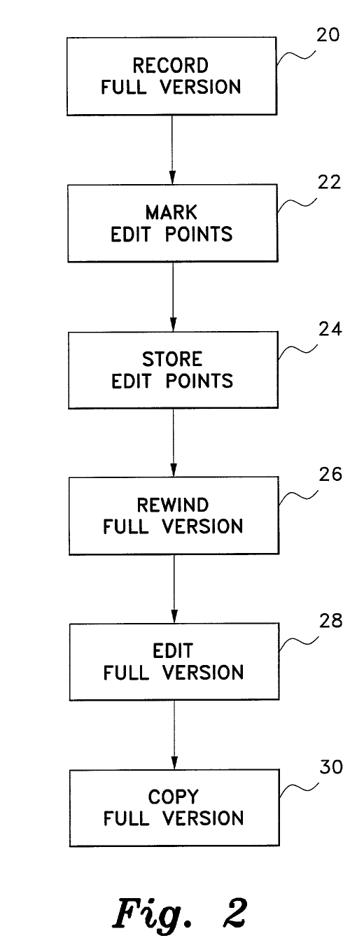

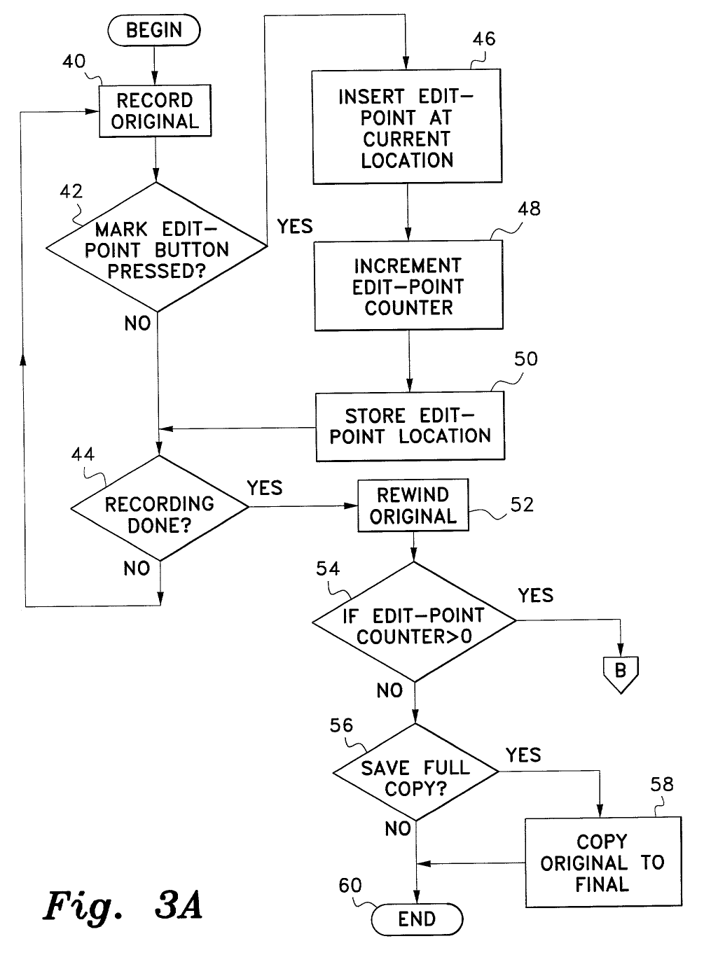

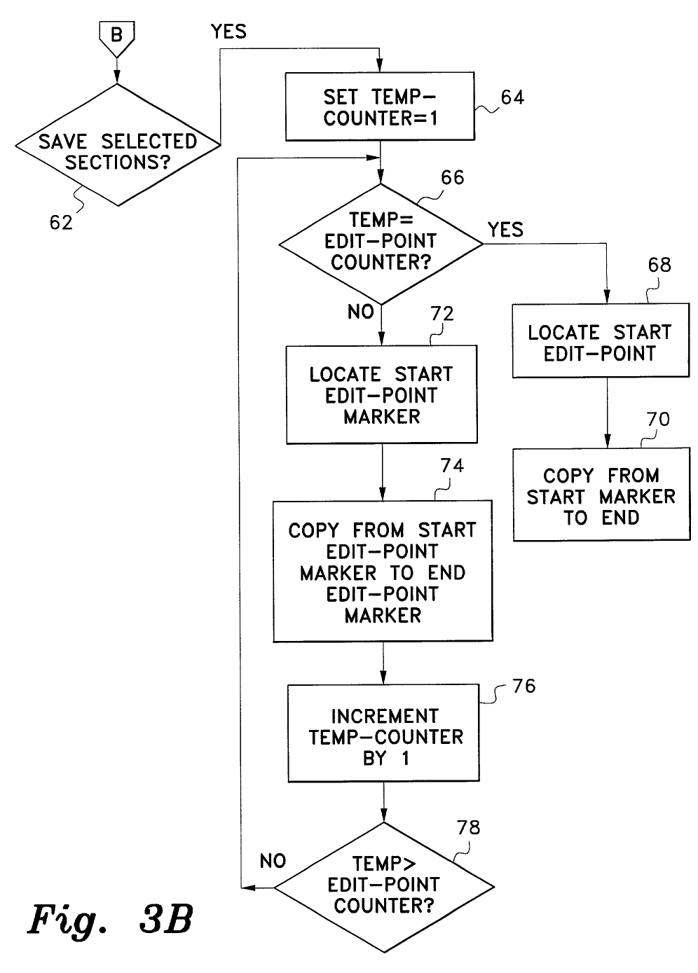

The operation of the redactable recording apparatus is best understood by referring to FIGS. 2, 3A, and 3B. Consider a redactable recording apparatus student user wishing to generate a recording of a school lecture. The student would activate the redactable recording apparatus at the beginning of the lecture. A ‘full version’ recording device 20 would begin recording the lecture. During the lecture, the student user would mark and store edit points 22, 24 at desired times with ‘take a note’ buttons. At the end of the lecture, the student user would rewind 26 the ‘full version’ recording device or the ‘full version’ recording device would automatically rewind. During the rewind of the ‘full version’ recording device the microprocessor 16 will search for edit points marked and saved by the user. When an edit point was reached, the redactable recording apparatus would stop rewinding or retracking the ‘full version’ recording device and start playing the ‘full version’ recording device. At the same time the redactable recording apparatus would activate the ‘edit full version’ recording device 28 and record the ‘full version’ recording device contents 30 for the period of time designated by the edit point. This process continues throughout the length of the ‘full version’ recording device. FIGS. 3A and 3B illustrate an expanded flow chart of the flow chart shown in FIG. 2 of a recording process utilizing a redactable recording device apparatus according to the present invention. Accordingly the method of recording utilizing a redactable recording device according to the present invention, as illustrated by FIGS. 3A and 3B includes the general steps of:

(a) recording 40 a full version;

(b) marking 42 edit points;

(c) storing 50 edit points;

(d) rewinding or retracking 52 the full version;

(e) editing the full version 54, including the steps of the B branch of delineated in FIG. 3B; and

(f) copying the edited version 58.

As shown in FIG. 3A, the marking step 42 may further include the steps of:

(g) inserting an edit point at current location 46;

(h) incrementing the edit point counter 48;

(i) storing 50 the edit point location;

(j) saving 62 selected sections according to steps 64, 66, 68, 70, 72, 74, 76 and 78 delineated in FIG. 3B; and

(k) ending the process 60.

Obviously, the ‘full version’ recording device and the ‘edit full version’ recording device could be configured in the form of a single digital recording device with different memory locations.

This invention could be employed in the form of analog and digital personal cassette recorders, a Personal Digital Assistant with digital recording, a Personal Digital Assistant/personal cassette recorder combination. A Personal Digital Assistant could output to a personal computer or convert notes to text for printing. This invention could be configured in the form of a software product to run on personal computers to monitor conversation through a microphone or telephone, and could be either stand alone or used with a series of stations as in a conference or classroom. This invention could be configured in the form of a software product that could process television or audio signals coming through a dedicated tuner, the Internet or signals from a standard television, video cassette recorder, or stereo that could be sent to the personal computer via a cable and interface card. The software could process signals from a camcorder or any other device that has the electronic marking capability.

The invention could be configured in the form of an integrated system including a camcorder and a dual cassette (or triple cassette if the user wanted continuous monitoring capability) video cassette recorder so that the camcorder only needs the electronic signaling electronics and one cassette. When the user returns home, the camcorder would be attached to the video cassette recorder and the editing process would then be done. This video cassette recorder would also be able to monitor television signals and use the editing process on them without the camcorder. The invention could be configured in the form of a stand alone camcorder system with dual or triple cassettes or digital storage. There could be one or more digital storage devices and one analog cassette or digital media device such as a disc, etc. to transfer the edited material to, in the form of all analog or all digital, respectively. In this regard the invention as herein described would utilize an “auto-buffer” storing feature for selectively storing multimedia (i.e. voice, audio, video or still images).

In the case of an analog or digital device which makes use of a linear recording medium (i.e. tape media such as VHS, beta, cassettes, etc.), this feature of the invention would require a main recording tape to be a loop tape such that when the “auto-buffer” storage feature is activated a buffer period would be set or calibrated to the length of the tape by default (including the use of optional speed enhancing features for high speed “dubbing”). In the instance of a nonlinear digital recording device, that is an integrated circuit recorder, hard drive or the like, a buffer period could be selectively determined by a user for selectively storing multimedia data as desired. The recording devices can be linked in series and synchronized to provide continuous or selective coverage by a user for virtually an indefinite time period. The nature of recording, would be left only to one's imagination and creativity in formulating a multimedia end-product or master-piece reflecting unique attributes of the user. In a proverbial sense, literally: “A work of art”.

It is to be understood that the present invention is not limited to the embodiments described above, but encompasses any and all embodiments within the scope of the following claims.

I claim:

1. A redactable recording apparatus with at least one recording device housed in a single unit for conveniently recording an event and generating a recorded edited version of the event.

2. A redactable recording apparatus according to claim 1, further comprising a microprocessor and a memory device.

3. A redactable recording apparatus according to claim 1, further comprising an output device to provide the ability for a user to review the contents of the recording devices.

4. A redactable recording apparatus according to claim 1, further comprising a ‘take a note’ button for encoding an electronic signal onto a recording device relating to a predetermined period of time.

5. A redactable recording apparatus according to claim 1, further comprising a power device.

6. A method of recording multimedia utilizing the redactable recording apparatus according to claim 1, comprising the steps of:
(a) recording a full version;
(b) marking at least one edit point;
(c) storing the at least one edit point;
(d) rewinding the full version;
(e) editing the full version; and
(f) copying the edited version.

7. The method of recording according to claim 6, wherein the marking step (b) further comprises the steps of:
(g) inserting an edit point at current location to define an edit point location;
(h) incrementing an edit point counter;
(i) storing the edit point location; and
(j) saving selected edit point locations.

8. The method of recording according to claim 6, wherein the storing step (b) includes selectively storing said at least one edit point for recording multimedia.

9. The method of recording according to claim 8, wherein the rewinding step (b) includes selectively retracking the full version for selectively storing said multimedia.

10. A method of recording multimedia utilizing the redactable recording apparatus, comprising the steps of:
(a) recording a full version;
(b) marking at least one edit point;
(c) storing the at least one edit point;
(d) rewinding the full version;
(e) editing the full version; and
(f) copying the edited version.

11. The method of recording according to claim 10, wherein the marking step (b) further comprises the steps of:
(g) inserting an edit point at current location to define an edit point location;
(h) incrementing an edit point counter;
(i) storing the edit point location; and
(j) saving selected edit point locations.

12. The method of recording according to claim 10, wherein the storing step (b) includes selectively storing said at least one edit point for recording multimedia.

13. The method of recording according to claim 12, wherein the rewinding step (b) includes selectively retracking the full version for selectively storing said multimedia.
